(19) United States
(12) Patent Application Publication
(10) Pub. No.: US 2026/0149644 A1
(43) Pub. Date: May 28, 2026

(54) COMMUNICATIONS NETWORK MANAGEMENT

(71) Applicant: British Telecommunications Public Limited Company, London Greater London (GB)

(72) Inventors: Kjeld JENSEN, London Greater London (GB); Paul TAYLOR, London Greater London (GB); Stephen CASSIDY, London Greater London (GB); Botond VIRGINAS, London Greater London (GB); Lucy GULLON, London Greater London (GB); David YEARLING, London Greater London (GB)

(21) Appl. No.: 19/122,046

(22) PCT Filed: Sep. 14, 2023
(86) PCT No.: PCT/EP2023/075260

§ 371 Date: Apr. 17, 2025

(30) Foreign Application Priority Data
Oct. 27, 2022 (EP) 22204235.0

(51) Int. Cl. H04L 41/14; H04L 41/142; H04L 41/147

(52) U.S. Cl. CPC H04L 41/145; H04L 41/142; H04L 41/147

(57) ABSTRACT

A method for managing a communications network comprises receiving, as input to a multi-armed bandit, a decision instance defining a task for managing the communications network and environmental data. An arm of the multi-armed bandit is selected, wherein each arm comprises a model of a respective action from a plurality of possible actions that can be taken in response to the received decision instance. For the selected arm, execution of the associated action on the communications network is triggered to produce an outcome. The observed outcome of the selected arm is compared with an outcome predicted by the model of the selected arm. Using the comparison determine whether to update the model of the selected arm with a historic model, wherein the historic model defines a previously determined relationship between the action corresponding to the selected arm, the received decision instance and the environmental data.

The present disclosure relates to communications network management, including but not limited to fibre to the premises (FTTP) provisioning, communications network deployment, communications network fault resolution, communications network maintenance.

### BACKGROUND

Communications network management is a complex and time-consuming process involving many factors and types of activities such as: fibre to the premises (FTTP) provisioning, communications network deployment, communications network fault resolution, communications network maintenance. FTTP provisioning involves deploying optical fibre from an existing optical fibre communications network to a premises in order to give the premises access to the optical fibre communications network. Communications network deployment more broadly comprises adding communications network nodes or edges to existing communications networks and/or deploying entirely new communications networks. Communications network fault resolution and maintenance comprises manual and/or automated processes such as sending instructions over the network to a faulty node to trigger restart of the node or to trigger download of new firmware to the node.

The examples described herein are not limited to examples which solve problems mentioned in this background section.

### SUMMARY

Examples of preferred aspects and embodiments of the invention are as set out in the accompanying independent and dependent claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In a first aspect of the disclosed technology there is method for managing a communications network, the method comprising:
receiving, as input to a multi-armed bandit, a decision instance and environmental data, wherein the decision instance defines a task for managing the communications network and wherein the environmental data comprises data relating to the task;
using the received decision instance and the environmental data, selecting an arm of the multi-armed bandit, wherein each arm comprises a model of a respective action from a plurality of possible actions that can be taken in response to the received decision instance;
for the selected arm, triggering execution of the associated action on the communications network to produce an outcome;
observing, in the communications network, the outcome;
comparing the observed outcome of the selected arm with an outcome predicted by the model of the selected arm; and
determining, using the comparison, to update the model of the selected arm with a historic model, wherein the historic model defines a previously determined relationship between the action corresponding to the selected arm, the received decision instance and the environmental data.

By using the historic model to update the model of the selected arm it is possible to achieve improved accuracy of the communications network management. Since the communications network itself is naturally non-stationary, changes in the outcomes which are instantaneous or slowly establishing can be dealt with in an effective manner by using the historic model to update the model of the selected arm. In an example, coefficients of the historic model are populated into the model of the selected arm in order to carry out the update. In this way there is no need to re-learn the model of the selected arm from scratch when a change is observed so that time is saved and communications network resources are managed more efficiently.

In some preferred examples, the received decision instance is a request to deploy optical fibre to a premises as part of a fibre to the premises FTTP process. In an example where the decision instance is a request to deploy optical fibre as part of an FTTP process, at least one arm comprises a first type of engineering crew and at least one other arm comprises a second type of engineering crew which is different from the first type. In another example, concerning FTTP, at least one arm comprises a first combination of tasks and at least one other arm comprises a second combination of tasks which is different from the first combination. In another example concerning FTTP, at least one arm comprises a model of an action to deploy optical fibre overground to the premises, and at least one arm comprises a model of an action to deploy optical fibre underground to the premises; and wherein the environmental data comprises any one or more of: a distance from an optical fibre in the communications network to the premises, weather data, a number of available engineers, a type of optical fibre.

FTTP is a time consuming and complex process and by using the present technology to determine which actions to take from a plurality of possible FTTP provisioning actions, efficiencies are gained and quality and robustness of the deployed optical fibre communications network is enhanced.

In some preferred examples, the received decision instance is a request to configure a network element in the communications network in order to increase capacity of the communications network; and wherein each arm comprises a model of an action to configure the network element at a different location in the communications network; and wherein the environmental data comprises any one or more of: data about resources available at the different locations, traffic levels in the communications network, packet loss rates in the communications network. In some cases, configuring a network element is done by reconfiguring an existing network element. In some cases, configuring a network element comprises deploying an additional node in an automated manner so that there is a way of scaling up a communications network which is efficient and principled.

In some preferred examples, the received decision instance is a request to resolve a fault in the communications network; and wherein each arm comprises a model of an action to resolve the fault in a different manner; and wherein the environmental data comprises any one or more of: traffic levels in the communications network, packet loss rates in the communications network, topology of the communications network or other data. The action to resolve the fault may be an automated action. By using the multi-armed bandit to assist in fault resolution there is provided an efficient and effective means of fault resolution in communications networks.

In some preferred examples, selecting an arm of the multi-arm bandit comprises: predicting, using a respective model of each of a plurality of arms of the multi-armed bandit, a respective outcome;
comparing each predicted outcome with a predetermined criterion; and
selecting the arm of the multi-armed bandit based on a predicted outcome which most closely matches the predetermined criterion. Thus there is an effective and efficient way to select an arm of the multi-armed bandit which may then be used to trigger the action associated with the arm in the communications network. The triggering is done by a management node or any other computer implemented entity in the communications network and which is in communication with the multi-armed bandit. To trigger the action the management node sends instructions to one or more nodes in the communications network over a control plane or other communications plane in the communications network.

In some preferred examples, the method further comprises:
calculating a difference between the predicted outcome and the observed outcome of the selected arm;
using a change point detection algorithm, determining whether the calculated difference corresponds to a change point; and
in response to determining that the calculated difference corresponds to a change point, updating the model of the selected arm using the historic model. In this way the model of the selected arm is only updated when there is a significant change, such as the result of an instantaneous change or a slowly establishing change. By only updating when there is a significant change, undue updating of the model is avoided thus giving efficiency. A change point detection algorithm uses statistical techniques to identify anomalies in a time series by chunking up the time series into periods. By giving a time series of multi-armed bandit residuals to a change point detection algorithm it is possible to detect change points, which are points where the normal responses and incremental changes of the multi-armed bandit become inadequate. A multi-armed bandit residual is a difference between a predicted outcome computed by an arm of the multi-armed bandit and a corresponding observation. A non-exhaustive list of examples of change point detection algorithms is: variations of the upper confidence bound (UCB) algorithm, the Epsilon-Greedy algorithm, Thompson sampling, Sequential Collective Anomaly Point Anomaly—Upper Confidence Bound (SCAPA-UCB) Fisch, Bardwell and Eckley 2020 arXiv 2010.09353, PELT Killick et al 2012 arXiv 2009.06670.Using a change point detection algorithm is found to give good performance. By using a change point detection algorithm the need for the fixed threshold for comparing the residuals against is avoided which is useful since determining an appropriate threshold to use is difficult and time consuming.

In some preferred examples, the method further comprises:
estimating a round where the change point occurred, wherein a round comprises a respective previous decision instance; and
using previous observed outcomes and previous environmental data from the estimated round until a current round, updating the model of the selected arm using the historic model, wherein the current round is the received decision instance.

By taking into account the number of rounds it is possible to make a more informed decision about when to update the model of the selected arm so that there is improved accuracy overall.

In some preferred examples, the method comprises:
from the estimated round to the current round, collecting observed outcomes and corresponding environmental data;
determining, using a statistical model and the collected data, whether a previous historic model predicts one or more of the collected observed outcomes within an accuracy threshold; and
in response to determining that a previous historic model predicts one or more of the collected observed outcomes within the accuracy threshold, selecting the previous historic model to update the model of the selected arm. By using the collected data and the accuracy threshold the decision about when to update the model of the selected arm is further refined such that performance of communications network management is improved. The collecting of the previous observed outcome may involve collecting values at the point the decision is made. The values are stored in the store with the historical models or at any location accessible to the process.

In some preferred examples, selecting the previous historic model comprises:
ordering the previous historic models in order from most recent previous historic model to least recent previous historic model;
determining, using the statistical model and the collected data, whether a previous historic model in the order predicts one or more of the collected observed outcomes within the accuracy threshold, wherein the statistical model is applied in order starting with the most recent historic model; and
selecting a first previous historic model in the order that predicts one or more of the collected observed outcomes within the accuracy threshold to update the model of the selected arm, wherein the determination, using the statistical model, ceases to be applied once the first previous historic model in the order is selected.

By using chronological ordering in this way efficiencies are gained since fewer comparisons between the statistical model and the historic models are used in practice as compared with having a random ordering of the historic models. In practice, using a chronological ordering is found to give good working results.

In some preferred examples, the order of previous models is limited to a predetermined number of most recent historic models. By limiting the number of historic models to be considered efficiencies are gained since a search space of the historic models is reduced. It is unexpectedly found that this gives improved performance when the communications network management proceeds in real time even though many of the historic models are excluded from the analysis.

In some preferred examples, selecting the previous historic model comprises:
generating a list of historic models where long periods have been observed, wherein a period of a model is a number of rounds since a most recent change point was detected;
determining, using the statistical model and the collected data, whether a previous historic model from the list predicts one or more of the collected observed outcomes within the accuracy threshold; and
selecting a previous historic model from the list which most closely corresponds to the collected data to update the model of the selected arm. This approach gives improved accuracy in practice and results in good communications network management performance. Preferably, stationary behaviour comprises behaviour where a model representing a relationship between environmental data, predicted outcomes and observed outcomes is valid for a plurality of rounds.

In some preferred examples, the method comprises storing model coefficients for the selected arm in a model library. In this way a model library is built up which is useful for ongoing use of the process since there is more variety of models to use from the library. The model library is portable and can be used for managing different communications networks.

In another aspect of the disclosed technology there is a computer readable medium comprising computer-executable instructions that when executed by one or more processors cause the one or more processors to execute a method according to any one of the examples herein.

In another aspect of the disclosed technology there is a communications network, comprising:
a computer-implemented multi-armed bandit arranged to receive a decision instance and environmental data, wherein the decision instance defines a task for managing the communications network and wherein the environmental data comprises data relating to the task;
the computer-implemented multi-armed bandit arranged to use the received decision instance and the environmental data, to selecting an arm of the multi-armed bandit, wherein each arm comprises a model of a respective action from a plurality of possible actions that can be taken in response to the received decision instance;
a management node, arranged for the selected arm, to trigger execution of the associated action on the communications network to produce an outcome;
the management node arranged to observe, in the communications network, the outcome, to
compare the observed outcome of the selected arm with an outcome predicted by the model of the selected arm; and
   in response to the comparison, to update the model of the selected arm with a historic model, wherein the historic model defines a previously determined relationship between the action corresponding to the selected arm, the received decision instance and the environmental data. In this way it is possible to manage the communications network in an efficient, automated manner resulting in improved performance of the communications network as a whole.

It will also be apparent to anyone of ordinary skill in the art, that some of the preferred features indicated above as preferable in the context of one of the aspects of the disclosed technology indicated may replace one or more preferred features of other ones of the preferred aspects of the disclosed technology. Such apparent combinations are not explicitly listed above under each such possible additional aspect for the sake of conciseness.

Other examples will become apparent from the following detailed description, which, when taken in conjunction with the drawings, illustrate by way of example the principles of the disclosed technology.

### BRIEF DESCRIPTION OF THE DRAWINGS

FIG. 1 illustrates an example of a multi-armed bandit for use in executing a decision;

FIG. 2 illustrates an example of a decision process used by a multi-armed bandit;

FIG. 3 illustrates an example of a process for updating a model of a multi-armed bandit; and

FIG. 4 illustrates an example process for updating a model of an arm of a multi-armed bandit with a historic model;

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

The inventors have recognized that in communications network management, there are often a plurality of actions that may be taken in response to a given task (i. e different actions for completing the task). Where a decision about which action to take is to be made repeatedly over time, it is useful to have an automated tool which provides efficiencies in the decision-making process and leads to better quality communications network management.

The inventors have found that a multi-armed bandit (MAB), which is a self-learning and adaptive decision-making tool, is useful for making automated decisions repeatedly over time for managing a communications network. By using a MAB the inventors have found it is possible to learn an optimal action from a set of actions to be performed in connection with a communications network, such as deployment of optic fibre connections, addition of communications network nodes and other such actions.

The inventors recognize that where such MABs are used to predict likely outcomes, it is important that models used by the MAB are accurate. Where one or more models of a MAB is or are found to be inaccurate, it is possible to retrain the model(s) such as by updating their coefficients. However, the inventors have found that retraining the models is time consuming and suffers from the so called “cold start” problem whereby it is difficult to obtain a working solution from scratch since model coefficients are set to default or random values and do not necessarily give useful outcomes. As a result of the cold start problem communications network management performs poorly where a MAB is being used and one or more models of the MAB have to be retrained. The inventors have observed that retraining is found to be needed fairly frequently in communications network management scenarios such as where an adverse weather event occurs such that decisions about FTTP deployment which previously led to successful deployment are no longer workable. In another example, an unexpected high volume of traffic in a communications network, or an unexpected failure of a communications network node, are events which may lead to poor MAB performance and the need for retraining one or more MAB models.

In various examples, one or more historic models are used to update an arm of a MAB in a fast, efficient manner. In this way the cold-start problem and issues with re-training are avoided.

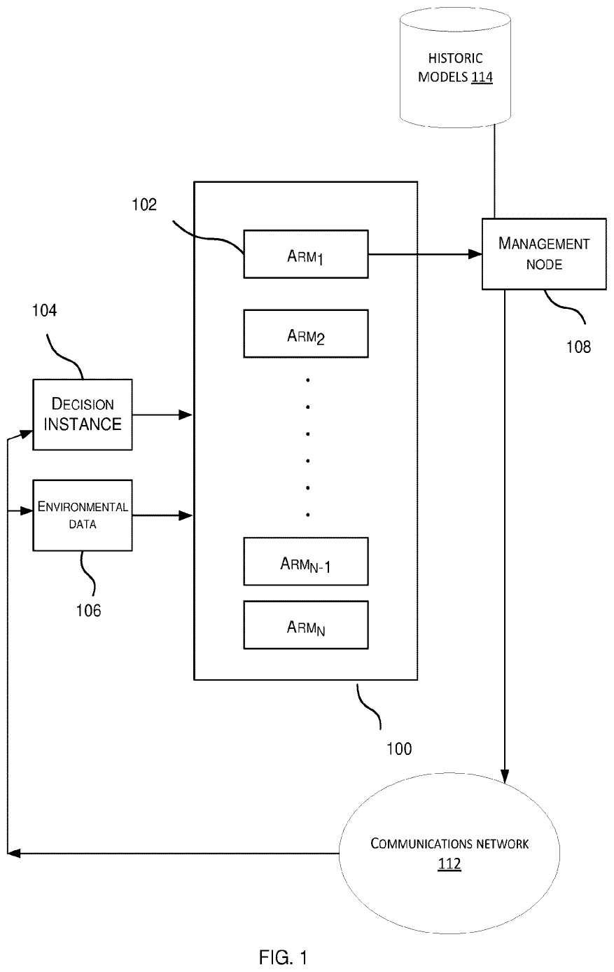

FIG. 1 shows an example of a contextual multi-armed bandit (MAB) 100 which is computer implemented and deployed at a node of a communications network 112 or at any computing entity in communication with communications network 112. In an example the MAB is software implementing a upper confidence bound (UCB) algorithm or any other commercially available MAB.

The MAB 100 comprises a plurality of arms 102 each being a model comprising a plurality of rules or relations and having a plurality of coefficients. Each arm represents a possible action from a finite plurality of N actions that may be taken in response to a decision instance. For example, a decision instance may be a task to be executed by a management node of the communications network 112 or by another entity.

The MAB 100 is in communication with a management node 108 of the communications network 112. The management node 108 is any computing device such as a desk top computer, a server, a smart phone. The management node 108 has access to a store of historic models 114 as described in more detail below.

In FIG. 1, the contextual MAB receives a decision instance 104, together with environmental data 106 related to a decision to be made by the MAB and then implemented in the communications network 112. Based on the received decision instance 104 and the environmental data 106, the contextual MAB selects an arm. By selecting one of the arms the MAB makes a decision. The action associated with the selected arm is then triggered by management node 108 and executed in the communications network 112. In some cases the action is implemented in the communications network 112 by engineers installing fibre to a premises for example, or by an engineer installing a new router in a telecommunications network. In some cases the action is implemented automatically by the management node 108 sending instructions to a node in the communications network 112 to trigger a restart, or to trigger download of new firmware or another automated action.

The MAB of FIG. 1 operates repeatedly to process incoming decision instances. The decision instances 104 are received from the communications network 112 itself, from an operator, or from the management node 108. In each decision round a choice is made between K possible actions, each action corresponding to an arm of the MAB. The letter K is used to denote a plurality of action. In various examples this choice is made on optimising a statistic that describes how well a communications network will perform when selecting a given action k from the K possible actions. Optimising a statistic comprises reducing an amount associated with the action, in some examples. That is, optimising the statistic may comprise reducing a number of communications network resources or time used to complete a task. As another example, optimising a statistic may comprise increasing a reward associated with the action. A reward may be improving a quality of a connection in a communications network, achieving a greater level of success of deployment of a communications network node etc.

For a chosen action k, a real-world outcome which arises due to selection of action k is observed in the communications network 112. This provides feedback regarding the accuracy of an arm of the MAB responsible for modelling action k. This feedback is then fed back into the MAB to improve the decision making for subsequent rounds. The feedback in some examples is binary in that it is determined whether the selection action k was successful or unsuccessful. In other examples, continuous feedback measures are used to determine the total cost of a decision or a weight sum of time to delivery and cost. The feedback is not illustrated in FIG. 1 for clarity.

In various examples, for a given decision, environmental data 106 is also provided to the MAB. Thus the MAB 100 of FIG. 1 is a contextual MAB. Environmental data 106 for each decision instance may comprise contextual information about each decision, such as a point in time when the decision instance arrives, data related to parameters of the decision to be carried out (e.g. location, risk, specialist equipment etc.). In addition or alternatively to contextual information, the environmental data may comprise information such as how many engineers are available with the skills required to complete the task. Any information that may impact the outcome for taking an action may be included in the environmental data.

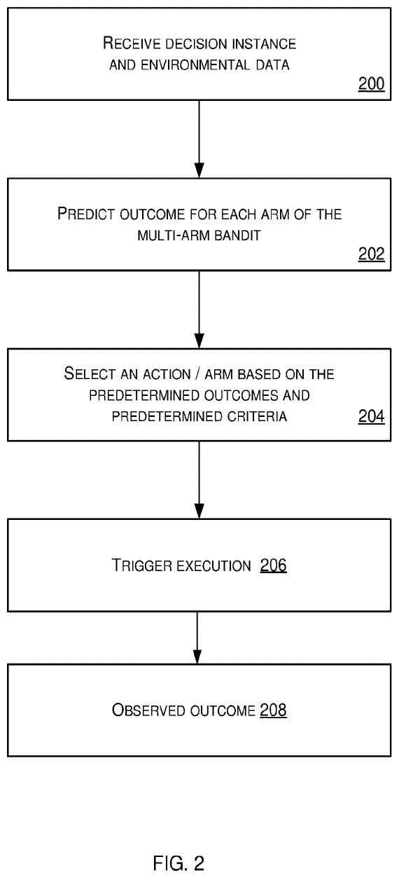

Referring to FIG. 2, an example is illustrated regarding how a MAB (such as MAB 100 of FIG. 1) is used with a management node 108 to manage a communications network 112. In FIG. 2, a decision instance and environmental data is received 200 by the MAB 100. The MAB predicts 202 an outcome for each action k of a finite set of actions K; that is, each arm in the MAB independently computes a prediction using the decision instance and the environmental data. Each prediction is a predicted outcome of taking an action associated with the particular arm. Based on the predicted outcomes and a predetermined criterion, the MAB 100 chooses to take 204 an action k. The MAB and/or management node triggers 206 execution of the action k. In some cases triggering the execution of the action comprises notifying an engineer. In some cases triggering the execution of the action comprises sending an automated instruction to the communications network 112. The outcome in selecting action k is observed 206. In some cases the observation is done by measuring packet drop rates in the communications network or measuring traffic levels in the communications network or making other measurements from the communications network 112. In some cases the observation is done by detecting a time at which optic fibre to a premises is first available for sending communications over the communications network. In some cases the observation is made by measuring performance characteristics of a newly installed optic fibre connection. Using the observed outcome, model coefficients of a model of the selected arm are updated.

Each arm of the MAB comprises a model of a respective action that may be selected in response to a decision instance. In each decision round, coefficients of the model corresponding to the selected action k are updated following observation of the outcome for the selected action k. As used herein, a decision round is a respective decision instance. That is, each time a decision instance is received at the MAB, this corresponds to another decision round. By updating the model coefficients in this way the models are able to learn.

In a stationary contextual MAB setting, it may be assumed that for each action, an underlying relationship between environmental data and the outcome for the selected action holds for all decision rounds t=1, 2, . . . T. However, the inventors have found that in the real world, the settings in which contextual MABs are applied are not stationary. A non-stationary contextual MAB extends the contextual MAB setting to settings in which a relationship between environmental data and observed outcomes changes over time for some or all of the K possible actions. The changes in a relationship between observed outcomes and environmental data may be instantaneous or may be slowly establishing.

As mentioned above, in non-stationary contextual MABs, to account for the change in relationship over time for some or all of the K actions, the coefficients of the respective models are typically re-trained. That is, after it is determined that a model no longer represents an accurate relationship between environmental data and observed outcomes, the respective model is re-trained to update its coefficients. This re-training step occurs each time it is determined that a model is no longer an accurate representation of the action to be modelled.

The re-learning of model coefficients from scratch to improve the accuracy of the model is time and resource intensive. Moreover, having to re-learn the model coefficients ignores useful and informative historic models. The examples described herein improve the efficiency of predicting which action to take in a resource-constrained setting by re-using historic models of a given action in the place of re-learning model coefficients from scratch.

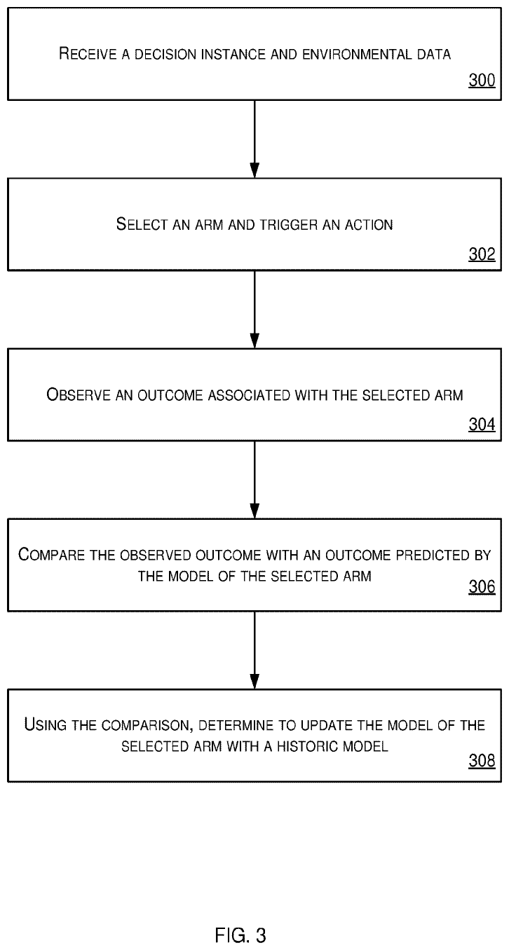

FIG. 3 illustrates various examples of a method used herein to update model coefficients. The method is performed by the management node 108 of FIG. 1 and/or by the MAB 100 of FIG. 1. The method illustrated in FIG. 3 may be applied to a variety of communications network management scenarios, including FTTP, resource allocation, network management and autonomous systems.

In FIG. 3, the method comprises receiving 300, as input to the muti-armed bandit (MAB), a decision instance and environmental data. The environmental data relates to the specific environment in which the MAB is to be utilised and the decision instance is a decision which is to be actioned in this specific environment. Using the received decision instance and environmental data, the method further comprises selecting 302 an arm of the MAB. Each arm of the MAB corresponds to a respective action from a plurality of actions that may be taken in response to the received decision instance. The action of the selected arm is triggered. In an example, the action is triggered by sending a notification to an engineer asking the engineer to install an optic fibre in a particular manner. In another example, the action is triggered by sending instructions to a node of the communications network 112.

Following execution of the action, an outcome associated with the selected arm is observed 304. Observation is done as described with reference to FIG. 2 or in any other suitable way. The observed outcome of the selected arm is compared 306 with an outcome predicted by the model of the selected arm. Where a model is performing as expected for a given action, some variation between the predicted outcome and the observed outcome of the action is normal. For example, incremental changes or small variations between a predicted outcome and an observed outcome are to be expected where the MAB is deployed in a physical environment. However, where these incremental differences lead to inaccurate or inadequate predictions, it is useful to determine that such an inaccurate or inadequate prediction has occurred. If a difference between the predicted outcome and the observed outcome is too great, then a determination 308 is made to update the model of the selected arm with a different model. Where it is determined, using the comparison, not to update the model of the selected arm with a different model, the model coefficients of the selected arm are updated using the observed outcome.

As an example, comparing the observed outcome of the selected arm with an outcome predicted by the model of the selected arm comprises calculating a difference between the predicted outcome and the observed outcome. The magnitude of this difference is used as part of a change point detection algorithm. When the change point detection algorithm detects a change point, the model of the selected arm is updated using a historic model. In an ideal scenario, the predicted outcome would be as close as possible to the observed outcome. Due to the predicted outcome being based on a model, there may inherently be differences between the predicted outcome and the observed outcome. A change point detection algorithm is used to identify when the normal responses and incremental changes of a MAB become in adequate.

Where a change point is detected, this is indicative that the model may not be accurately predicting an outcome of a given action. Consequently, it is useful to update the model for the respective arm. Therefore, in the case where a change point is detected, the method may comprise replacing a current model of the selected arm with a historic model for the selected arm.

Where it is determined that the difference between the predicted outcome and the observed outcome corresponds to a change point, it may be further estimated at which round this change occurred. For example, where a selected arm of the MAB is giving rise to an outcome which meets a given criteria—e.g. the observed outcome for the selected arm provides at least a threshold level of reward, performance, resource-saving etc., the model would not be replaced with a different model. This is because the selected arm and therefore model is an accurate model of what is being observed. As such, the model for a selected arm may not be changed at each round where a new decision instance is received. Scenarios in which the model is updated based on a different model (e.g. re-learning model coefficients from scratch or updating the model using a historic model), are where the model is inaccurate. This is because the use of an inaccurate model may lead to the selection of an action which provides an unsatisfactory action.

Where a given arm has been selected, and a corresponding model has been used, for a plurality of decision rounds, it is useful to determine a decision round at which the model no longer provides an accurate representation of the setting in which the MAB is deployed. For example, a change to an external environment of the setting may result in a selected model no longer providing an accurate prediction of the outcome of an action. Nevertheless, it is helpful to distinguish between where a model is providing an accurate prediction of an action and wherein the same model is providing an inaccurate prediction of the action.

To distinguish between where a given model is providing an accurate and an inaccurate prediction of an action, a round at which a change point occurred is estimated. This may be done, for example, using a change point detection algorithm. From the estimated round i at which the change occurred until a current round t corresponding to the received decision instance, the model of the selected arm is updated using a historic model. The selection of the historic model is based on previous observed outcomes and previous environmental data from the estimated round i until the current round t. The term “estimated round” is used to refer to a round of a last estimated change point, as detected by the change point algorithm.

In various examples, a number of decision rounds that have occurred since a previous change point is determined. This is because knowing a number of rounds since the previous change point is useful to determine whether there will be any gain in estimating the round at which the change point occurred. For example, if only a few rounds have occurred since the most recent change point prior to the present detected change point, there is no substantial gain from estimating when exactly a change occurred. However, if there are a large number of rounds, the model performance prior to the change point may be retained as an accurate model for the given action with the provided environmental data. This in turn helps retain a more accurate library of historic models.

However, if a large enough number of rounds have occurred since a round where a change was detected, it is useful to estimate where the change occurred. This is because prior to the change, the model of the selected arm fulfilled a predetermined criteria from the previous calculated change point to a round corresponding to the estimated change point. Thus, the model may be stored for the period of accurate behaviour from the round corresponding to the previous calculated difference until, but not including, the estimated round i at which the change occurred.

An example of how the estimated round, previous observed outcomes and previous environmental data may be used is by collecting each previous observed outcome and each corresponding previous environmental data from the estimated round i to the current round t. Using this data and a statistical model, it is determined whether a historic model predicts one or more of the collected observed outcomes within a predetermined accuracy threshold. In response to determining that a historic model predicts one or more of the collected observed outcomes within the accuracy threshold, this historic model is selected to update the model of the selected arm.

The selection of the historic model for updating of a current model of the selected arm may be performed in numerous ways. In some examples, the historic models are selected by ordering the historic models in order from most recent historic model to least recent historic model. Starting in order from the most recent historic model, it is determined, using the statistical model and the collected data, whether a historic model in the order predicts one or more of the collected observed outcomes within the accuracy threshold. The first historic model in the order that predicts one or more of the collected observed outcomes within the accuracy threshold is selected to update the model of the selected arm. The determination of whether a model in the order predicts one or more of the collected observed outcomes within the accuracy threshold ceases to be applied once the first historic model in the order that predicts one or more of the collected observed outcomes within the accuracy threshold is selected.

In this example, the order of previous models is limited to a predetermined number of most recent historic models. This limits a number of calculations that the MAB may have to perform. Additionally, this method performs well in scenarios where recent behaviour is considered to be more relevant to new behaviour. In an example there are two storm periods which change the performance of FTTP provision either side of a change to the FTTP engineering process. When a new storm arrives it is better to select the historical model that is most recent (i.e. after the engineering process change) over the older model, even though both candidates relate to storm conditions.

In other examples, instead of ordering the historic models from most recent to least recent, a list of historic models where long periods of stationary behaviour have been observed is generated. As used herein, a period of a model is a number of rounds since a most recent change point was detected. A long period comprises more than a specified number of rounds where the specified number is set by an operator or set to a default value determined empirically. The list of historic models with long periods may be selected using a change point detection algorithm. This is done, for example, using embedded statistical methods of the change point detection algorithm. Using the statistical model and the collected data, it is determined whether a historic model from the list predicts one or more of the collected observed outcomes within the accuracy threshold. A historic model is selected from the list which most closely corresponds to the collected data to update the model of the selected arm. A long period of stationary behaviour may be considered to be stationary behaviour where a model representing a relationship between environmental data, predicted outcomes and observed outcomes is valid for a plurality of rounds.

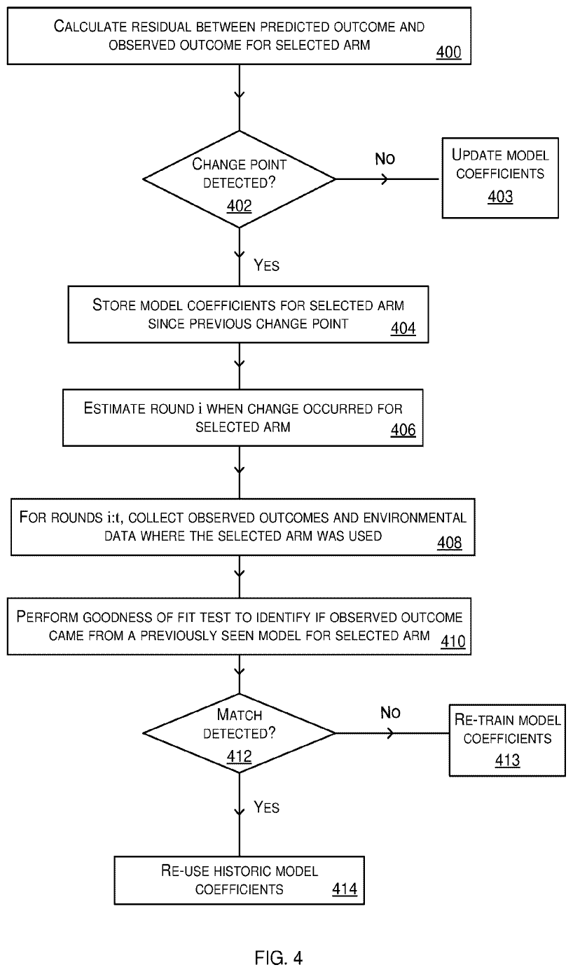

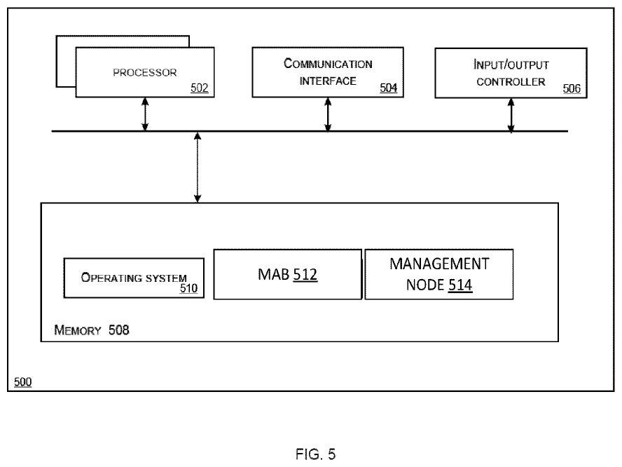

An example method of detecting a change point and using the estimated change point to select a historic model is depicted in FIG. 4. In FIG. 4, a residual between a predicted outcome and an observed outcome for an arm corresponding to action k is calculated 400. It is determined 402 whether a change point has occurred. If it is determined that a change point has not occurred, the model coefficients of the selected arm are adjusted 403 using the observed outcomes.

If a change point has been detected, the model coefficients for the selected arm are stored 404 since the previous change point. A round i when a most recent change point occurred for the selected arm is estimated 406. For decision rounds i to a current round t, the observed outcomes and environmental data where the selected arm was used are collected 408. A statistical model, such as a goodness of fit test, is performed 410 to identify whether observed outcomes match a previously seen model for the selected arm. The method further comprises determining 412 whether a match is detected. If a match is detected, historic model coefficients are re-used 414 to update the model of the selected arm. Otherwise, the model of the selected arm is re-trained 413 based on the observed outcomes.

Any change-point detection algorithm may be used to estimate a round at which a change occurred. For example, any of the change point detection algorithms mentioned earlier in this document. A change point detection algorithm tracks the residuals between the observed and predicted outcomes of having taken an action. Where a change is detected in the residuals, the change point detection algorithm provides an estimate of when the change occurred.

In an example the apparatus and methods described here are used in a fibre to the premises (FTTP) provision process. During FTTP provision, a decision is made each time an order or a job arrives thus a decision instance is a request for installing optic fibre to a particular premises. There are several possible ways to install the optic fibre such as installing it overhead using a cherry picker apparatus and an engineering team, or installing the optic fibre underground using earth moving apparatus and an engineering team skilled in underground optic fibre cable laying. In another example, a hybrid of overhead and underground installation is used. These possible ways are referred to as job types.

The decision to be made is to assign each order as a job of type 1:N. Each job type n is actioned in a different way, using different resources and incurring different costs. Environmental data about each order is available at the point at which an order arrives. Examples of environmental data include but are not limited to: information about the job itself (job location, risk, specialist equipment used etc.), information about resources to be used to complete the job (how many engineers are available with the skills to do the job etc.). The job relates to a task for providing fibre to the premises.

Once the MAB has selected an arm using the decision instance and the environmental data, the action associated with the arm is triggered. In an example, a notification is sent to an engineering team leader instructing installation of optic fibre overhead to a particular premises and using specified equipment and people. An outcome of the action is observed.

The outcome may be a binary indication of whether a job is successful. For example, this may be whether a job is on-time. Instead of a binary indication, continuous measures are used in some cases. Such continuous measures may relate to the total cost of a job or a weighted sum of time, delivery and cost. The nature of FTTP provision is naturally non-stationary. Changes in the distribution of the outcomes of the system could be instantaneous or could be slowly establishing. As an example, a change caused by an extreme weather event may cause a step-change in the outcome distribution for each action and changes in the workforce, i.e. upskilling, may cause slow drift-like change.

In some cases the outcome is observed automatically from behaviour in the communications network 112 such as by receiving a message from the premises over the optic fibre.

Once the MAB has been used in FTTP provisioning over a plurality of rounds it is possible to determine whether one or more of the arms are to be retrained using the process of FIG. 4. Where a change occurs in the behaviour of outcomes for an action, it may lead to a new relationship between the environmental data and the observed outcomes. However, this is not always the case. For various changes, similar relationships between environmental data and observed outcomes to those which were observed in the past may occur. Continuing with the example of extreme weather events in the FTTP provision process, during and in the period shortly following the event, the actions to incoming orders to achieve successful on time delivery and installation may be different. However, after some recovery period, the past relationship between environmental data and outcomes observed before the weather event may return.

If actions of a MAB are selected in response to the changes in the setting without taking into account the non-stationary behaviour of the environment, the model between environmental data and observed outcomes may be re-learnt after each change event. This approach would ignore useful and informative models from past periods of stationary behaviour. Additionally, this process saves time re-training the model from scratch, i.e., time spent taking sub-optimal actions, and thus also has a physical impact on the real-world allowing saving of cost and resources such as engineer hours.

In an example the apparatus and methods described here are used in a communications network for operational decision making. Operational decision-making concerns the day-to-day running of a communications network. It is therefore useful for tools that aid operational decision-making to be reactive and adaptive to changes in the decision environment. In autonomous systems, operational decisions are undertaken by a self-governing agent. Non-stationary contextual MABs are well suited to this setting however, typically, there has been little consideration of how to react upon encountering a change in the decision environment. The methods disclosed herein establish a post-change processing method that re-uses historical information to provide a warm start for modelling the relationship between environmental data and outcomes of actions.

Two examples of autonomous systems are optimal delivery of network capability and self-governing/self-healing network infrastructure. Starting with the example of optimal delivery of network capability, this relates to processes such as resource or network provision where sequential decision instances are observed over time. In this example, some action relating to the deployment of a resource such as a communications network node or edge is taken upon the observation of each instance. This allows the opportunity to explore, exploit and ultimately learn an optimal course of action over time. The decision instance is received from the communications network 112 itself or from an operator. The decision instance is a request to deploy an additional communications network node in some cases and the arms of the MAB represent different ways of deploying the additional network node (such as different types of communications network node, different topologies for connecting the additional network node, whether to deploy the additional network node whilst the communications network is offline or whether to deploy the additional network node whiles the communications network is live). The environmental data comprises observed behaviour of the communications network, availability of different types of communications network node, compatibility of different types of communications network equipment, existence of service level agreements). The MAB selects an arm and the associated action is triggered by sending instructions to automatically deploy the additional network node or by notifying an engineer to manually install it. The observed outcome is automatically obtained by observing the communications network behaviour. The arm models are updated as appropriate and stored in the historical models store as illustrated in FIG. 1.

Turning to the example of self-governing/self-healing network infrastructure, this relates to the maintenance and healthy operation of a network in the face of real (and often unexpected) events, such as system failures or traffic surges. Here, the network may be described as being composed of a number of self-governing (autonomous) components that may learn from both local and global behaviours. This facilitates the maintenance of an overall network service.

In the context of network maintenance, examples of jobs or orders may be to resolve detected faults in a system. For example, there may be a switch or a router in the core system that fails. There may be an access point to the network that is blocked. These represent some jobs or orders that a MAB may be tasked with resolving. As these decision instances arrive, there are a plurality of actions that may be taken. The MAB predicts an action to take which resolves the problem and triggers a selected action to be executed in the communications network 112.

For each of the autonomous examples, there exists a sequential process of events where each event triggers an action to be taken. For autonomous systems, the decision of what action to take is made by an agent which interacts with a sequential decision-making tool, an example being some MAB algorithm. The tool selects an action, from a finite set of possible actions, that maximises some objective/outcome related to reward, cost, or even information gain. In various examples, the outcome is a measure of reward for taking an action. Each action will cause a different outcome, use different resources, and incur different costs.

On observing an outcome, there is environmental data which enables the inferring of the value of the reward of each action. The reward may be binary, discrete, or continuous, and may represent a single performance metric or a weighted function of measures that summarise the system performance given an action. Where a change occurs in the behaviour of outcomes for an action, it may lead to a new relationship between environmental data and outcomes, but this is not always the case. For some changes, similar relationships between environmental data and outcomes may be observed to those have been observed in the past.

FIG. 5 illustrates various components of an example computing device 500 in which embodiments of a MAB and an optional management node for managing a communications network are implemented in some examples. The computing device is of any suitable form such as a smart phone, a desktop computer, a server, a data centre compute node.

The computing device 500 comprises one or more processors 502 which are microprocessors, controllers or any other suitable type of processors for processing computer executable instructions to control the operation of the device in order to perform the methods of FIGS. 1 to 4. In some examples, for example where a system on a chip architecture is used, the processors 502 include one or more fixed function blocks (also referred to as accelerators) which implement a part of the method of FIGS. 1 to 4 in hardware (rather than software or firmware). That is, the methods described herein are implemented in any one or more of software, firmware, hardware. The computing device has a data store holding historical models, model coefficients, outcomes, measurements and other data in some cases. The computing device has a multi-armed bandit 512 and optionally a management node 514. Platform software comprising an operating system 510 or any other suitable platform software is provided at the computing-based device to enable application software to be executed on the device. Although the computer storage media (memory 508) is shown within the computing-based device 500 it will be appreciated that the storage is, in some examples, distributed or located remotely and accessed via a network or other communication link (e.g. using communication interface 504).

The computing-based device 500 also comprises an input/output controller 506 arranged to output display information to a display device which may be separate from or integral to the computing-based device. The display information may provide a graphical user interface such as to display notifications to an engineer or communications network operator. The input/output controller 506 is also arranged to receive and process input from one or more devices, such as a user input device (e.g. a mouse, keyboard, camera, microphone or other sensor).

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The steps of the methods described herein may be carried out in any suitable order, or simultaneously where appropriate. The arrows between boxes in the figures show one example sequence of method steps but are not intended to exclude other sequences or the performance of multiple steps in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A method for managing a communications network, the method comprising:
receiving, as input to a multi-armed bandit, a decision instance and environmental data, wherein the decision instance defines a task for managing the communications network and wherein the environmental data comprises data relating to the task;
using the received decision instance and the environmental data, selecting an arm of the multi-armed bandit, wherein each arm comprises a model of a respective action from a plurality of possible actions that can be taken in response to the received decision instance;
for the selected arm, triggering execution of the associated action on the communications network to produce an outcome;
observing, in the communications network, the outcome;
comparing the observed outcome of the selected arm with an outcome predicted by the model of the selected arm; and
determining, using the comparison, to update the model of the selected arm with a historic model, wherein the historic model defines a previously determined relationship between the action corresponding to the selected arm, the received decision instance and the environmental data.

2. The method of claim 1 wherein the received decision instance is a request to deploy optical fibre to a premises as part of a fibre to the premises FTTP process.

3. The method of claim 1 wherein the received decision instance is a request to configure a network element in the communications network in order to increase capacity of the communications network; and wherein each arm comprises a model of an action to configure the network element at a different location in the communications network; and wherein the environmental data comprises any one or more of: data about resources available at the different locations, traffic levels in the communications network, packet loss rates in the communications network.

4. The method of claim 1 wherein the received decision instance is a request to resolve a fault in the communications network; and wherein each arm comprises a model of an action to resolve the fault in a different manner; and wherein the environmental data comprises any one or more of: traffic levels in the communications network, packet loss rates in the communications network, topology of the communications network.

5. The method of claim 1, wherein selecting an arm of the multi-arm bandit comprises:
predicting, using a respective model of each of a plurality of arms of the multi-armed bandit, a respective outcome;
comparing each predicted outcome with a predetermined criterion; and
selecting the arm of the multi-armed bandit based on a predicted outcome which most closely matches the predetermined criterion.

6. The method according to claim 4, further comprising:
calculating a difference between the predicted outcome and the observed outcome of the selected arm;
using a change point detection algorithm, determining whether the calculated difference corresponds to a change point; and
in response to determining that the calculated difference corresponds to a change point, updating the model of the selected arm using the historic model.

7. The method according to claim 6, further comprising:
estimating a round where the change point occurred, wherein a round comprises a respective previous decision instance; and
using previous observed outcomes and previous environmental data from the estimated round until a current round, updating the model of the selected arm using the historic model, wherein the current round is the received decision instance.

8. The method according to claim 7, further comprising:
from the estimated round to the current round, collecting observed outcomes and corresponding environmental data;
determining, using a statistical model and the collected data, whether a previous historic model predicts one or more of the collected observed outcomes within an accuracy threshold; and
in response to determining that a previous historic model predicts one or more of the collected observed outcomes within the accuracy threshold, selecting the previous historic model to update the model of the selected arm.

9. The method according to claim 8, wherein selecting the previous historic model comprises:
ordering the previous historic models in order from most recent previous historic model to least recent previous historic model;
determining, using the statistical model and the collected data, whether a previous historic model in the order predicts one or more of the collected observed outcomes within the accuracy threshold, wherein the statistical model is applied in order starting with the most recent historic model; and
selecting a first previous historic model in the order that predicts one or more of the collected observed outcomes within the accuracy threshold to update the model of the selected arm, wherein the determination, using the statistical model, ceases to be applied once the first previous historic model in the order is selected.

10. The method of claim 9, wherein the order of previous models is limited to a predetermined number of most recent historic models.

11. The method of claim 8, wherein selecting the previous historic model comprises:
generating a list of historic models where long periods have been observed, wherein a period of a model is a number of rounds since a most recent change point was detected;
determining, using the statistical model and the collected data, whether a previous historic model from the list predicts one or more of the collected observed outcomes within the accuracy threshold; and
selecting a previous historic model from the list which most closely corresponds to the collected data to update the model of the selected arm.

12. The method of claim 11, wherein generating the list comprises using the change point detection algorithm to select the historical models that have long periods.

13. The method of claim 1, further comprising:
storing model coefficients for the selected arm in a model library.

14. A computer readable medium comprising computer-executable instructions that when executed by one or more processors cause the one or more processors to execute a method according to claim 1.

15. A communications network, comprising:
a computer-implemented multi-armed bandit arranged to receive a decision instance and environmental data, wherein the decision instance defines a task for managing the communications network and wherein the environmental data comprises data relating to the task;
the computer-implemented multi-armed bandit arranged to use the received decision instance and the environmental data, to selecting an arm of the multi-armed bandit, wherein each arm comprises a model of a respective action from a plurality of possible actions that can be taken in response to the received decision instance;
a management node, arranged for the selected arm, to trigger execution of the associated action on the communications network to produce an outcome;
the management node arranged to observe, in the communications network, the outcome, to compare the observed outcome of the selected arm with an outcome predicted by the model of the selected arm; and
in response to the comparison, to update the model of the selected arm with a historic model, wherein the historic model defines a previously determined relationship between the action corresponding to the selected arm, the received decision instance and the environmental data.
